(19) United States
(12) Patent Application Publication
(10) Pub. No.: US 2008/0187275 A1
(43) Pub. Date: Aug. 7, 2008

(54) Plastic fiber optic with gradient index and method

(76) Inventors: Olivier Schuepbach, Lignieres (CH); Jacques Goudeau, Irigny (FR); Sandrine Francois, Lyon (FR)

Correspondence Address: SOFER & HAROUN LLP., 317 MADISON AVENUE, SUITE 910, NEW YORK, NY, 10017, US

(21) Appl. No.: 11/511,181

(22) Filed: Aug. 28, 2006

(30) Foreign Application Priority Data
Aug. 24, 2005 (FR) 05 52557

(51) Int. Cl. G02B 6/44

(52) U.S. Cl. 385/101

(57) ABSTRACT

The present invention relates to a perfluorinated plastic graded-index optical fiber 51, including a core 52 of fluorinated polymer doped with a fluorinated compound, an optical cladding 53 in fluorinated polymer with an index less than that of said core 52, surrounding said core 52, as well as a strengthening layer 54 in polymer material, surrounding said optical cladding 53.

The invention is remarkable in that the optical fiber 51 further includes a protective layer 55 in a photo-crosslinkable resin surrounding said strengthening layer 54, and the polymer material of the strengthening layer 54 is a material different from that of the protective layer 55.

The present invention relates to a plastic graded-index optical fiber, the core and optical cladding of which are made in fluorinated polymer materials.

The invention also relates to a method for making such a plastic optical fiber.

The invention finds a particularly advantageous application, but not exclusively, in the field of optical telecommunications.

A perfluorinated plastic graded-index optical fiber may have its optical properties changed if excessive temperature and/or too large mechanical stresses are applied to it during its making and/or its installation and/or its normal use.

To remedy such a difficulty, integrating this type of plastic optical fiber inside a hollow polymer material body forming both a structural reinforcement and heat insulator was contemplated.

Such a solution however has the drawback of being particularly expensive, owing to both the cost price of the large supplement of required material, and to the overrunning manufacturing costs related to the structural complexity of the assembly, which notably imposes the making of specific tooling.

Also the technical problem to be solved by the object of the present invention, is to propose a perfluorinated plastic graded-index optical fiber, including a fluorinated polymer core doped with a fluorinated compound, an optical cladding in fluorinated polymer with an index less than that of said core, surrounding said core, as well as a strengthening layer in polymer material, surrounding said optical cladding, a plastic optical fiber with which problems of the state of the art may be avoided by notably providing substantially improved temperature strength and resistance to mechanical stresses, while having limited additional cost as compared with a standard fiber.

The solution to the posed technical problem according to the present invention consists in that the optical fiber further includes a photo-crosslinkable resin protective layer surrounding said strengthening layer, and the polymer material of the strengthening layer is a material different from that of the protective layer.

The invention as thereby defined, has the advantage of being able to have a perfluorinated plastic optical fiber intrinsically benefiting from efficient protection against heat excesses and too intense deformation forces which may occur during manufacturing and/or installation and/or use. A simple external layer in a photo-crosslinkable polymer is actually able to significantly improve heat resistance and the mechanical strength of the fiber, without resorting to an expensive structurally insulating independent reinforcement as in the state of the art.

By applying a photo-crosslinkable resin coating to the outside of a perfluorinated plastic graded-index optical fiber, it is also possible to substantially improve the optical properties of said fiber. This improvement is above all expressed by systematic widening of the pass-band, but also by a more or less significant reduction in optical attenuation.

This result proves to be rather unexpected as it is not observed in the distinct field of silica optical fibers. In the present case, it is a priori explained by the fact that during its process for coating it with the protective layer, the perfluorinated plastic optical fiber undergoes a slight heat treatment which promotes release of internal stresses generated beforehand during its hot-drawing. Logically, this relaxation of internal stresses is what causes the observed improvement in optical performances.

It should be noted that unlike silica optical fibers, the photo-crosslinkable resin layer does not simply play the role here of a mechanical protection, but mainly that of a heat protection.

This feature advantageously provides the possibility of depositing an extra-layer of polymer material, directly onto a perfluorinated plastic optical fiber according to the invention, by using a standard high temperature coating method, such as an extrusion for example. With the heat shield which the protective layer forms, excessive temperatures may actually be avoided, which might normally change the optical properties of the perfluorinated plastic optical fiber, and more particularly its attenuation.

The presence of a protective layer external to the surface of a perfluorinated plastic optical fiber is also an advantage in terms of differentiation as a photo-crosslinkable resin is a material which is extremely easy to colour.

According to a particularity of the invention, the photo-crosslinkable resin of the protective layer is an urethane acrylate.

More advantageously, the photo-crosslinkable resin of the protective layer may include at least a non-halogenated flame retarder compound.

According to another advantageous feature, the thickness of the protective layer is between 0.1 and 2 millimetres.

According to another particularity of the invention, the polymer material of the strengthening layer is selected from polymethylmethacrylate (PMMA), and mixtures of polycarbonate and polyesters.

According to another particularly advantageous feature, the fluorinated polymer of the core and of the optical cladding is Cytop®.

First Manufacturing Method

The invention also relates to a first method for manufacturing a perfluorinated plastic graded-index optical fiber as described earlier.

This first manufacturing method is remarkable in that it includes the steps of:
coating with a photo-crosslinkable resin intended to form a protective layer, a standard perfluorinated plastic optical fiber including a fluorinated polymer core doped with a fluorinated compound, an optical cladding in a fluorinated polymer with an index less than that of said core, as well as a strengthening layer in polymer material,
cross-linking the photo-crosslinkable resin of the protective layer by ultraviolet radiation.

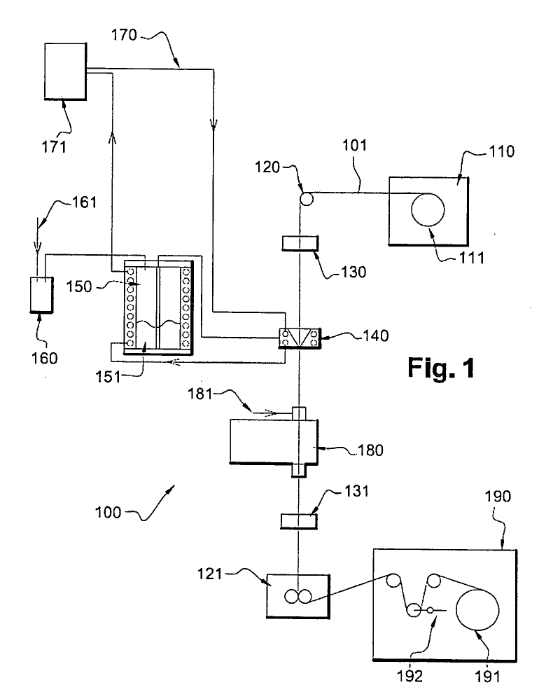

FIG. 1 illustrates a device 100 with which this first manufacturing method according to the invention may be applied.

The relevant manufacturing device 100 basically uses a standard perfluorinated plastic optical fiber 101, in this case a fiber which conventionally consists of a doped Cytop core, extending inside a non-doped Cytop optical cladding, the whole being covered with a PMMA strengthening layer.

In this exemplary embodiment, the standard plastic optical fiber 101 is stored around a spool 111 which is itself placed on a let-off reel 110.

Once it is unwound, the standard fiber 101 passes around a guide pulley 120 which is responsible for providing its alignment relatively to a series of apparatuses 130, 140, 180, 131, involved in actually carrying out the coating.

First of all there is a first measuring instrument 130 which continuously records the diameter of the standard fiber 101 before it has undergone the coating treatment.

A coating head 140 then applies around the standard fiber 101, a coating 151 based on photo-crosslinkable resin of the urethane acrylate type which is stored in a tank 150. It is observed that the coating pressure is controlled by a pressure regulator 161 which is fed with nitrogen via a conduit 161. But, it is also noted that from the point of view of temperature, the coating head 140 is controlled via a cooling circuit 170 which causes water to flow between a cryothermostat 171 and the coating head 140, via the coating tank 150.

An ultraviolet radiation lamp 180 then cross-links the previously applied coating, under an inert atmosphere consisting of nitrogen from a conduit 181.

Immediately afterwards, a second measuring instrument 131 is, this time, positioned for continuously recording the diameter of the fiber after treatment, i.e., after coating and cross-linking. By comparing the values read with those of the first measuring instrument 130, it is possible to determine the changes in thickness of the protective layer in order to check its quality.

At the lower portion of the manufacturing device 100, the coated fiber passes through a capstan 121 which is responsible for exerting continuous traction on said fiber during the whole coating process.

The coated fiber is finally wound around a receiving reel 191 which is mounted on a winder 190. With a floating arm 192 it is possible to check the winding speed which typically varies between 30 and 500 m/min.

Second Manufacturing Method

Moreover, the invention relates to a second method for manufacturing a perfluorinated plastic graded-index optical fiber as described earlier.

This second manufacturing method is characterized here by the fact that it includes the steps of:
hot-drawing a standard perfluorinated plastic optical fiber preform including an internal portion which consists of fluorinated polymer doped with a fluorinated compound and which is intended to form the core, an intermediate portion which consists of a fluorinated polymer and which is intended to form the optical cladding with an index less than that of said core, as well as an external portion which consists of polymer material and which is intended to form the strengthening layer,
coating the previously drawn primary fiber with a photo-crosslinkable resin intended to form the protective layer,
cross-linking the photo-crosslinkable resin of the protective layer with ultraviolet radiation.

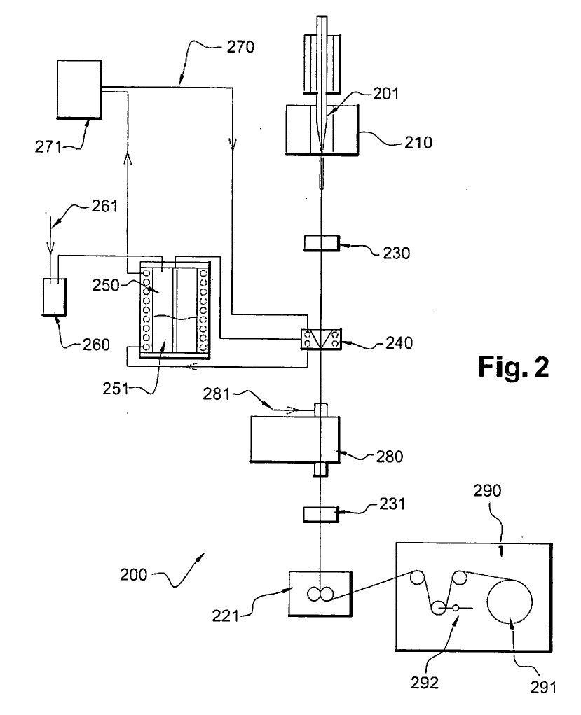

As for FIG. 2, it illustrates a device 200 with which the second manufacturing method according to this invention may be applied.

The relevant manufacturing device 200 basically uses a standard tubular preform 201 of a perfluorinated plastic graded-index optical fiber. In this exemplary embodiment, this preform 201 in its internal portion consists of doped Cytop intended to form the core, in its intermediate portion, of non-doped Cytop intended to make the optical cladding, and in its external portion, of PMMA intended to make up the strengthening layer.

As this may be seen in FIG. 2, the standard preform 201 is introduced into a drawing oven 210. The transmitted heat melts the end of the preform 201 which is then drawn as a primary fiber.

Once it is drawn, the primary fiber is directed through a series of apparatuses 230, 240, 280, 231, involved in the actual making of the coating.

First of all, there is a first measuring instrument 230 which continuously records the diameter of the primary fiber before it has undergone the coating treatment.

An induction head 240 then applies around the primary fiber, a coating 251 based on photo-crosslinkable resin of the urethane acrylate type which is stored in a tank 250. it is observed that as in the previous case, the coating pressure is controlled by a pressure regulator 260 which is fed with nitrogen via a conduit 261. But in the same way, it is noted that the coating head 240 is also thermally controlled, via a cooling circuit which causes water to flow between a cryothermostat 271 and the coating head 240, via the coating tank 250.

An ultraviolet radiation lamp 280 then cross-links the coating which has just been applied, in an inert atmosphere which consists of nitrogen brought through a conduit 281.

Immediately afterwards, a second measuring instrument 231 is positioned in order to continuously record the diameter of the previously coated fiber. By comparing the values read with those of the first measuring instrument 230, the changes in thickness of the protective layer are there also determined for checking its quality.

At the lower portion of the manufacturing device 200, the coated fiber passes through a capstan 221 which is responsible for exerting continuous traction on said fiber during the whole coating process.

The coated fiber is finally wound around a receiving reel 291 which is mounted on a winder 290. With a floating arm 292 it is possible to control the winding speed which typically varies between 20 and 100 m/min.

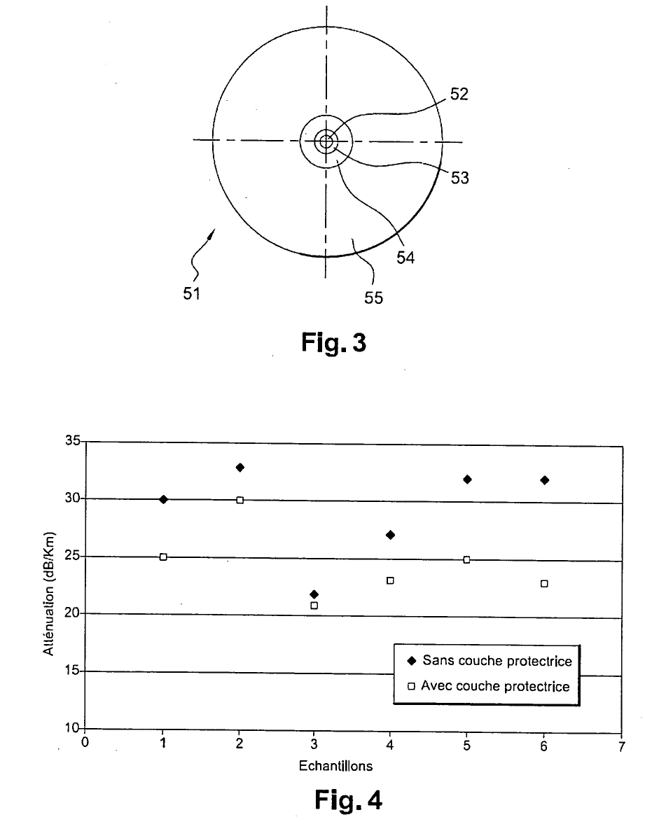

FIG. 3 is a cross-section which illustrates a typical example of perfluorinated plastic optical fiber 51 according to the invention. The strengthening layer of this fiber 51 is made in PMMA, and the external diameter of the protective layer 55 attains 2,200 μm.

As it may be seen in FIG. 3, in each type of fiber 51, the different layers 52, 53, 54, 55 are provided in a perfectly concentric way.

Other features and advantages of the present invention will become apparent during the description of the examples which follows, the latter being given as an illustration and by no means as a limitation.

The goal of these examples is to perform a comparison between the properties of a perfluorinated plastic optical fiber according to the invention and those of a reference perfluorinated plastic optical fiber from which it is derived.

As a reference component a same perfluorinated plastic optical fiber of standard type is therefore used. In this case, this is a fiber which conventionally consists of a core of doped Cytop, a extending inside an optical cladding in non-doped Cytop, the whole being covered with a PMMA strengthening layer.

From this reference fiber, a coated fiber according to the invention is prepared by applying the first previously described manufacturing method, for example. The retained parameters are a processing speed between 25 and 35 m/min, and an ultraviolet radiation lamp power from 3 to 15 W/cm. The cross-linkable resin selected for forming the protective layer is an urethane acrylate resin.

Optical Attenuation

A first series of attenuation measurements is performed by means of a reflectometer on six consecutive standard fiber samples, i.e., six samples without any protective layer. A second series of measurements in then conducted on six consecutive coated fiber samples. It should be noted that each sample has a length of 300 m.

FIG. 4 illustrates the different results of these measurements. An improvement in the average attenuation of the order of 4.8 dB/km, is clearly observed which substantially corresponds to a reduction of about 15%.

Passband

One then proceeds with measurements of passbands on both types of perfluorinated fibers. Table 1 groups the average values of the performed measurements.

TABLE 1

| | without any | with a |
|---|---|---|
| Sample | protective layer | protective layer |
| numerical aperture | 0.17 | 0.16 |
| pass-band (MHz · km) | 596 | 1070 |
| Ø core (μm) | 124 | 125 |
| Ø optical cladding (μm) | 230 | 224 |
| Ø strengthening layer | 486 | 483 |
| (μm) | | |

A strong increase in the bandwidth is noted here, from the moment that the fiber is provided with a protective layer according to the invention. Moreover it should be noted that this effect is more marked than for the optical attenuation, but above all, it is perfectly reproducible.

Heat Resistance

Cycling tests are applied according to the IEC 60793-1-52 standard; in order to evaluate the impact of a protective layer on the heat resistance of a perfluorinated plastic optical fiber. For each type of fiber, tests were conducted on three samples and only the average values were retained.

In this way after ten temperature cycles conducted between −20° C. and +70° C., it is seen that the coated fiber has a significantly lower additional attenuation than that of the standard fiber. Indeed, the average value of the additional attenuation is +4.7 dB/km in the case of the coated fiber, whereas it attains+15.7 dB/km for the reference fiber.

Thus, now, a perfluorinated plastic optical fiber according to the invention provides less sensitivity to changes in temperature than the reference fiber. In other words this means that the protective layer is somewhat able to play a role of a heat shield capable of protecting the fiber from possible heat excesses.

Temperature and Humidity Resistance

One then proceeds with aging tests at 65° C., 95% relative humidity, and for a treatment period of 19 days. The goal here is to evaluate and compare the resistance to temperature and humidity of the reference fiber on the one hand and of the coated fiber according to the invention on the other hand.

In concrete terms, by means of a reflectometer, an optical attenuation measurement is performed before aging on each type of fiber, and then a series of measurements at regular time intervals during aging. Table 2 groups the average values calculated from different measurements.

TABLE 2

| | with a | without any |
|---|---|---|
| Sample | protective layer | protective layer |
| Attenuation | 27.3 | 27.6 |
| before aging (dB/km) | | |
| Attenuation after | 39.8 | 65.6 |
| aging (dB/km) | | |
| Attenuation | 12.5 | 38.0 |
| difference (dB/km) | | |

It is clearly seen that aging generates degradation of the attenuation by 12.4 dB/km for the coated fiber, whereas this is 38 dB/km for the standard fiber. Improvement in the resistance to temperature and humidity is therefore very clear from the moment that the perfluorinated plastic optical fiber is provided with an external coating in photo-crosslinkable resin.

1. A perfluorinated plastic graded-index optical fiber comprising:
a core of fluorinated polymer doped with a fluorinated compound,
an optical cladding in fluorinated polymer with an index less than that of said core, surrounding said core,
as well as a strengthening layer in polymer material, surrounding said optical cladding, wherein
the optical fiber further includes a protective layer in photo-crosslinkable resin surrounding said strengthening layer, and
the polymer material of the strengthening layer is a material different from that of the protective layer.

2. The plastic optical fiber according to claim 1, wherein the photo-crosslinkable resin of the protective layer is an urethane acrylate resin.

3. The plastic optical fiber according to any of claim 1, wherein the photo-crosslinkable resin of the protective layer includes at least a non-halogenated flame-retarder compound.

4. The plastic optical fiber according to claim 1, wherein the thickness of the protective layer is between 0.1 and 2 millimeters.

5. The plastic optical fiber according to claim 1, wherein the polymer material of the strengthening layer is selected from the group consisting of polymethylmethacrylate (PMMA) and mixtures of polycarbonate and polyester.

6. The plastic optical fiber according to claim 1, wherein the fluorinated polymer of the core and of the optical cladding is Cytop.

7. A method for manufacturing a perfluorinated plastic graded-index optical fiber according to any of the preceding claim 1, wherein said method includes the steps of:
coating with a photo-crosslinkable resin intended to form a protective layer, a standard perfluorinated plastic optical fiber including a core of fluorinated polymer doped with a fluorinated compound of larger index, an optical cladding in fluorinated polymer, as well as a strengthening layer in polymer material,
cross-linking the photo-crosslinkable resin of the protective layer with ultraviolet radiation.

8. A method for manufacturing a perfluorinated plastic graded-index optical fiber according to claim 1, wherein said method includes the steps of:
hot-drawing a standard perfluorinated plastic optical fiber preform including an internal portion which consists of a fluorinated polymer doped with a fluorinated compound of larger index and which is intended to form the core, an intermediate portion which consists of a fluorinated polymer and which is intended to form the optical cladding, as well as an external portion which consists of polymer material and which is intended to form the strengthening layer,
coating the conventional previously drawn fiber with a photo-crosslinkable resin intended to form the protective layer,
crosslinking the photo-crosslinkable resin of the protective layer with ultraviolet radiation.
